(19) United States
(12) Patent Application Publication
(10) Pub. No.: US 2025/0313287 A1
(43) Pub. Date: Oct. 9, 2025

(54) CRAWLER TRACK LINK FOR A SUPPORT CARRIAGE OF A MACHINE FOR LAYING OR RENOVATING A RAILWAY LINE AND ARTICULATED ASSEMBLY OF SUCH

(71) Applicant: MATISA MATÉRIEL INDUSTRIEL S.A., Crissier (CH)

(72) Inventors: Jacques PILET, Vufflens-la-Ville (CH); Jérôme KINSEY, Vevey (CH)

(73) Assignee: MATISA MATÉRIEL INDUSTRIEL S.A., Crissier (CH)

(21) Appl. No.: 18/865,059

(22) PCT Filed: May 12, 2023
(86) PCT No.: PCT/EP2023/062830

§ 371 Date: Nov. 12, 2024

(30) Foreign Application Priority Data
May 13, 2022 (FR) FR2204587

(51) Int. Cl. B62D 55/21; B62D 55/14

(52) U.S. Cl. CPC B62D 55/21; B62D 55/14

(57) ABSTRACT

The invention relates to a link (10) for a crawler track (100) for a support carriage (1) of a machine for laying or renovating a railway line, comprising a one-piece metal part (11) defining two axes of articulation (A1, A2) that are parallel to and spaced apart from one another, the one-piece metal part (11) having a central portion (12) located between the two axes of articulation (A1, A2) and two opposing end portions (13, 14) on either side of the central portion (12), each of the end portions (13, 14) being associated with one of the two axes of articulation (A1, A2) and comprising a plurality of parallel fingers (15) which are separated in pairs by finger-free spaces (16) and through which holes (17) pass, which holes are aligned along the associated axis of articulation (A1, A2), the one-piece metal part (11) comprising a rolling surface (18) located on one side of a geometric reference plane (P) that contains the two axes of articulation (A1, A2) and a surface (19) opposite to the rolling surface (18), located on another side of the geometric reference plane (P), the opposing surface (19) being covered with a layer of elastomeric material (20) that covers the central portion (12) and at least part of each of the fingers (15) of the two end portions (13, 14).

### TECHNICAL FIELD OF THE INVENTION

The invention relates generally to the technical field of machines for laying or renovating a railway line.

The invention relates more specifically to a crawler track link for a support carriage of a machine for laying or renovating a railway line, to an articulated assembly of at least two such links, a crawler track running gear for a support carriage of a machine for laying or renovating a railway line, comprising a crawler track consisting of such an articulated assembly, and a support carriage of a machine for laying or renovating a railway line equipped with at least one such crawler track running gear.

### PRIOR ART

Builders or managers of rail transport networks regularly need to build new tracks or rebuild existing ones, i.e. to replace some of their components such as rails and sleepers supporting the rails, as well as fasteners and other accessories. Much of this need for renewal is due to track wear, but it can also involve replacing older models with newer ones to enable better performance. Such track-laying or track-renovating operations are carried out using a train comprising multiple specialized machines to perform the various very specific operations.

During these operations, the train is generally required to operate on a section of track without rails, in particular directly on sleepers.

Crawler solutions are available, configured to move along the trackless section during track-laying or track-renovating operations.

However, for reasons of cost and life expectancy, rail replacement is increasingly out of phase with sleeper replacement. The problem of protecting the sleepers over which a crawler travels during these operations is therefore becoming increasingly important.

Solutions to this problem are known, such as the one disclosed in document DE202021001054, which proposes to surround the crawler tread with a strip of protective rubber material. However, such mechanisms are complex because they involve managing the separate movement of the crawler tread and the rubber protection belt and, in practice, generate a number of constraints during use that require regular maintenance operations, for example to protect these elements from the external environment and avoid degrading their operation.

### DISCLOSURE OF THE INVENTION

The invention aims to remedy all or some of the disadvantages of the prior art, in particular by proposing a solution that provides better protection for sleepers, especially at their chamfers, during rail laying or replacement operations, while improving the simplicity and reliability of the carriages in the train.

According to a first aspect of the invention, a crawler track link is proposed for a support carriage of a machine for laying or renovating a railway line, comprising a one-piece metal part defining two axes of articulation that are parallel to and spaced apart from one another, the one-piece metal part having a central portion located between the two axes of articulation and two opposing end portions on either side of the central portion, each of the end portions being associated with one of the two axes of articulation and comprising a plurality of parallel fingers which are separated in pairs by finger-free spaces and through which holes pass, which holes are aligned along the associated axis of articulation, the one-piece metal part comprising a rolling surface situated on one side of a geometric reference plane that contains the two axes of articulation and a surface opposite to the rolling surface, located on another side of the geometric reference plane, the opposing surface being covered with a layer of elastomeric material that covers the central portion and at least part of each of the fingers of the two end portions.

Thanks to this combination of features, the link is protected on the side opposite its rolling surface by the layer of elastomeric material, which enables it to withstand forces by being in direct contact with the sleepers. Once assembled with a plurality of other similar links to form a crawler track, a plurality of layers of elastomeric material can be obtained, positioned in discontinuous ways, as said layers of elastomeric material are specific to each link, but whose overlapping, on the opposing surface, of the central portion and of at least part of each of the fingers of the two end portions, makes it possible to ensure support of the links of such a track on a portion of track without rails during which a layer of elastomeric material is always present.

In one embodiment, the layer of elastomeric material completely covers a main portion of the opposing surface delimited by the two axes of articulation, and covers at least part of the fingers of the two end portions beyond the main portion. Such links, assembled together to form a crawler track, guarantee continuity of the elastomeric material by maximizing the contact surface.

In one embodiment, the main portion of the opposing surface is flat. This encourages an optimized contact surface.

According to another embodiment, the layer of elastomeric material has a thickness greater than or equal to 6 mm, preferably greater than or equal to 10 mm and/or less than or equal to 15 mm, preferably less than or equal to 12 mm.

According to one embodiment, the end of each of the fingers is rounded, the rounding of each of said fingers preferably being delimited by a rounded connecting face forming the junction between a face of the rolling surface and a face of the opposing surface.

In one embodiment, the layer of elastomeric material has curved portions each covering a rounded portion of the end of each of the fingers on the side opposite the rolling surface.

In one embodiment, the layer of elastomeric material is continuous, and preferably has a constant thickness.

In one embodiment, the elastomeric material constituting the layer comprises rubber, preferably consists of rubber.

In one embodiment, the layer of elastomeric material has a hardness greater than or equal to 92 Shore A, and/or less than or equal to 97 Shore A. Such a hardness provides improved resistance for use in the railway sector.

In one embodiment, the distance between the axes of articulation of the end portions is greater than or equal to 45 mm and/or less than or equal to 55 mm. Thanks to such a center-to-center distance, the size of the links is sufficiently reduced to improve the contact surface on the sleepers of the track being laid or renovated.

In one embodiment, at least some of the fingers on each of the two end portions have flat transverse guide side faces perpendicular to the axes of articulation, delimiting the finger-free spaces pairwise.

In one embodiment, the fingers of one of the two end portions are each positioned between two planes perpendicular to the axes of articulation and delimiting finger-free spaces of the other of the two end portions.

In one embodiment, the rolling surface comprises two rolling tracks separated by a guide rib.

According to another aspect, the invention relates to an articulated assembly of at least two links as described above, remarkable in that the fingers of an end portion of a first of the two links are inserted into the finger-free spaces of an end portion of a second of the two links so as to be criss-crossed, the articulated assembly further comprising a hinge pin inserted into the holes of each of the criss-crossed fingers of the first and second links.

An example of an articulated assembly is a crawler track, which corresponds to an endless chain of such links articulated pairwise.

In one embodiment, the links are identical.

In one embodiment, the elastomeric strips of the links overlap in pairs in a direction perpendicular to the transverse direction of the frame.

According to a further aspect, the invention also relates to a crawler track running gear for a support carriage of a machine for laying or renovating a railway line, comprising a crawler track consisting of an articulated assembly of a plurality of links as described above, assembled successively in pairs and comprising a frame carrying crawler-track-guiding rollers for rolling on the rolling surfaces of the crawler track links.

In one embodiment, the center-to-center distance between two adjacent rollers is greater than or equal to 45 mm and/or less than or equal to 55 mm.

In one embodiment, the rollers have axes parallel to the axes of articulation of the links, with a center-to-center distance of the rollers being strictly greater than the value of one center-to-center distance between the axes of articulation of the links and strictly less than the value of twice the center-to-center distance between the axes of articulation of the links.

According to another aspect, the invention further relates to a support carriage of a machine for laying or renovating a railway line, remarkable in that it comprises at least one crawler track running gear as described above, preferably at least two lateral running gears.

### BRIEF DESCRIPTION OF THE FIGURES

Other features and advantages of the invention will become apparent on reading the following description, with reference to the appended figures, which show:

FIG. 1: an isometric perspective view of a support carriage of a machine for laying or renovating a railway line according to one embodiment;

FIG. 2: an isometric perspective top view of a crawler-tracked running gear for the support carriage of FIG. 1;

FIG. 3: a front view of the crawler-tracked running gear of FIG. 2;

FIG. 4: a bottom isometric perspective view of the crawler-tracked running gear of FIG. 2;

FIG. 5: a view of a crawler track link of the crawler-tracked running gear of FIG. 2;

FIG. 6: an isometric perspective view of part of a crawler track of the crawler-tracked running gear of FIG. 2;

FIG. 7: a bottom view of the crawler track of FIG. 6;

FIG. 8: a front view of the crawler track of FIG. 6.

For greater clarity, identical or similar elements are identified by identical reference signs in all of the Figures.

In the description and the claims, to clarify the description and the claims, the terminology longitudinal, transverse and vertical will be adopted in reference to the trihedron X, Y, Z indicated in the figures.

### DETAILED DESCRIPTION OF AN EMBODIMENT

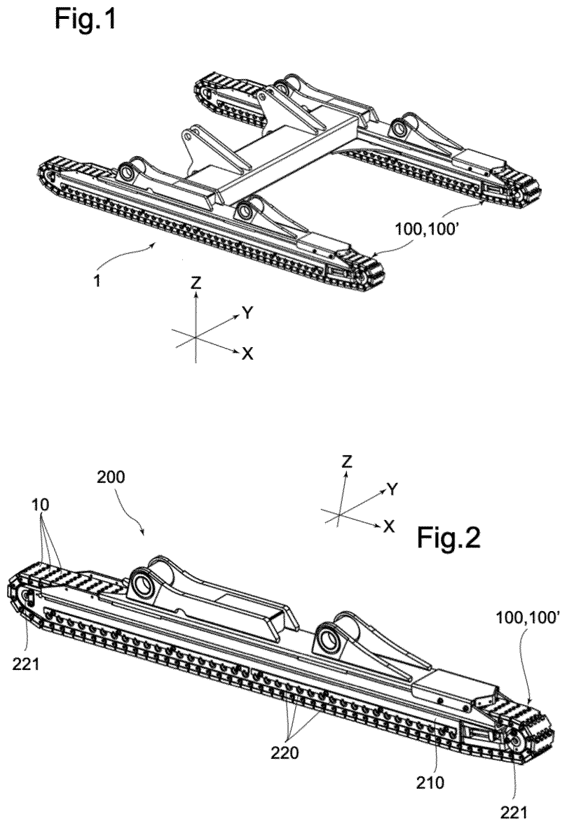

FIG. 1 illustrates a view of a support carriage 1 of a machine for laying or renovating a railway line (not shown), according to one embodiment. The support carriage 1 comprises two running gears 200 arranged laterally with respect to the support carriage 1 and parallel to each other symmetrically with respect to a vertical plane parallel to a longitudinal direction X of the support carriage 1.

Each lateral running gear 200 comprises a frame 210 carrying rollers 220 for guiding a crawler track 100 to guide said crawler track 100 during its rotational movement around the guide rollers 220.

The frames 210 of the two running gears 200 are connected together to form the main frame of the support carriage 1. This main frame, as well as the frames 210 of each of the two running gears 200, have fastening interfaces for attaching, in particular, a set of means for connection to the machine for laying or renovating the railway line. For example, these fastening interfaces are configured to receive at least one deformable parallelogram and means for controlling it, comprising a set of cylinders for example, so as to be able to move the support carriage 1 at least along a vertical component. In this way, it is possible to raise the support carriage 1 to a raised position relative to a rolling plane P0, and lower the support carriage 1 to a position where the tracks 100 rest and bear against a rolling surface contained in the rolling plane P0.

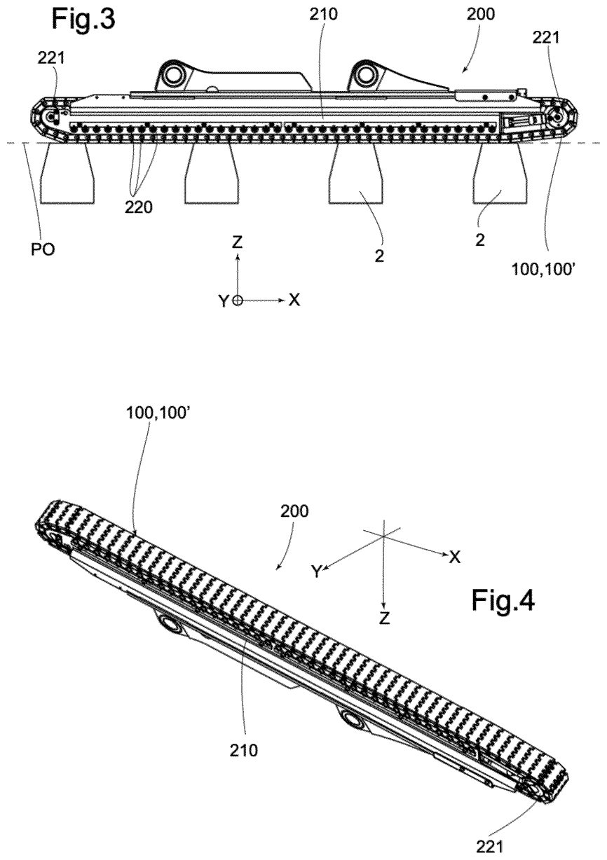

A running gear 200 as shown in FIG. 1 is illustrated in greater detail in FIGS. 2, 3 and 4.

The track 100 consists of an articulated assembly 100′ of a plurality of links 10. In this way, each track 100 of an associated running gear 200 defines an endless chain, or loop, of links 10 articulated in pairs around the guide rollers 220 located on the same side of the support carriage 1, associated with one of the given lateral running gears 200, so as to be interposed between them and the rolling plane P0.

Each link 10 of the crawler track 100 comprises a one-piece metal part 11 defining two axes of articulation A1, A2 that are parallel to and spaced apart from one another. Each of the two axes of articulation A1, A2 is parallel to a transverse direction Y of the associated frame 210. The metal part is one-piece 11 and has a central portion 12 located between the two axes of articulation A1, A2 and two opposing end portions 13, 14 on either side of the central portion 12. Each of the end portions 13, 14 is associated with one of the two axes of articulation A1, A2.

Each of the end portions 13, 14 comprises a number of parallel fingers 15 separated pairwise by finger-free spaces 16 and traversed by holes 17 aligned along the associated axis of articulation A1, A2.

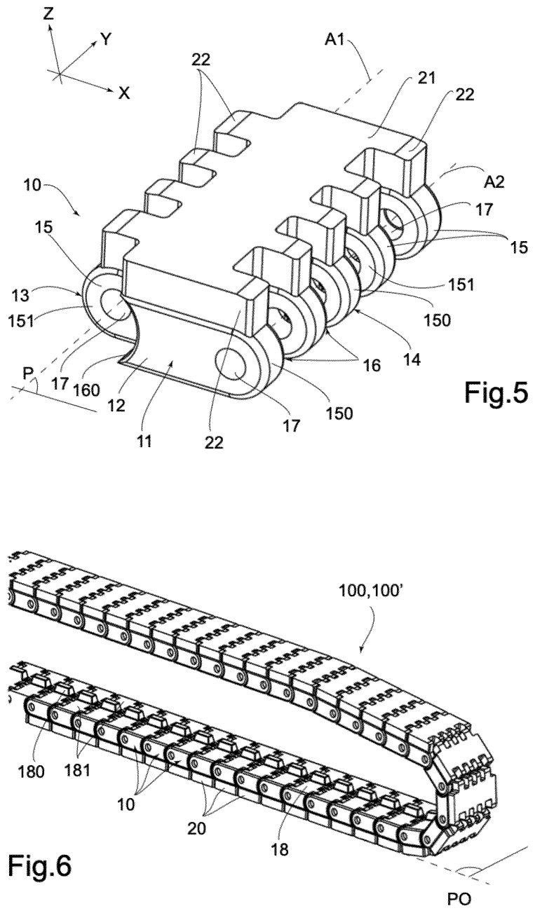

An example of a link 10 of this type is shown in greater detail in FIG. 5. The articulated assembly 100′ of these links 10 pairwise to form the crawler track 100 is illustrated in greater detail in FIGS. 6, 7 and 8.

The articulated assembly 100′ of two of the links 10 of the crawler track 100 is achieved when the fingers 15 of an end portion of a first of the two links 10 of the assembled links are inserted into the finger-free spaces 16 of an end portion of a second of the two links 10 of the assembled links so as to be criss-crossed. By criss-crossing the fingers 15 of two end portions 13, 14 of two separate links 10, it is possible to align the holes of each of the associated criss-crossed fingers 15, thus forming an orifice, here a through-hole, delimited by the succession of holes 17 of each of the fingers 15 in question, aligned along an axis parallel to a transverse direction Y of the associated frame 210. A hinge pin 117 inserted into this succession of aligned holes 17 in each of the criss-crossing fingers 15 of the end portions 13, 14 of two separate links 10 ensures a connection between these links 10. Note that each of the fingers 15 has a width, along an axis parallel to the transverse direction Y, which can be equal for the same end portion 13, 14, and preferably for the same link 10. However, the width of the fingers 15 can also be variable, for example increasing in width in the transverse direction Y from the center to the side edges of the end portions 13, 14 of the associated link 10.

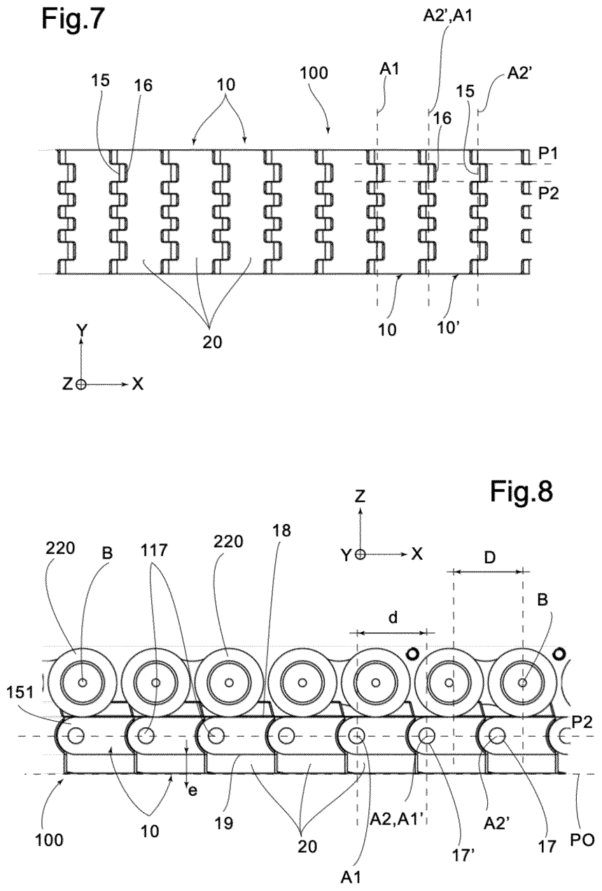

As illustrated in detail in FIGS. 7 and 8 with reference to two links 10, 10′ assembled together, each provided with two hinge pins A1, A2 and A1′, A2′ respectively: the holes 17 in the separate end portions of the two adjacent links 10, 10′ enable the two hinge pins A2, A1′ of the associated end portions to be shared so that they are coaxial in the crossed position to form the articulation between these two adjacent links 10, 10′.

In order to keep the hinge pin 117 in the articulated assembly 100′, and in particular to prevent it from moving in translation along the geometric axis of articulation A1, A2, it is locked in both directions by translational locking means. These locking means may comprise, for example, a shoulder against which the hinge pin 117 abuts on one side of the joint and a welding point located on the other side of the joint to weld it to the associated link 10.

For a given link 10, the one-piece metal part 11 comprises:
a rolling surface 18 located on one side of a geometric reference plane P containing the two axes of articulation A1, A2, this rolling surface 18 being located on an inner side of the crawler track 100. The rolling surface 18 has two running tracks 181 against which the rollers 220 guiding the crawler track 100 roll, the running tracks 181 being separated by a guide rib 180, enabling simple guidance of the links 10 and therefore of the crawler track 100; and
a surface 19 opposite the rolling surface 18 located on another side of the geometric reference plane P, this opposing surface 19 being located on an outer side of the track 100.

In accordance with the invention, the opposing surface 19 is covered by a layer of elastomeric material 20 covering the central portion 12 and at least part of each of the fingers 15 of the two end portions 13, 14. As this layer of elastomeric material 20 is located on the outward-facing side of the track 100, opposite the frame 210, it ensures good grip of the carriage on the rolling surface, contained in the rolling plane P0. In addition, this layer of elastomeric material 20 prevents damage to the material against which the support carriage 1 is placed. In particular, when the support carriage 1 is placed on a portion of a railway line without rails, i.e. directly on sleepers 2 of the railway line, the layer of elastomeric material 20 is interposed between the associated link 10 and the sleepers 2, thus protecting said sleepers 2.

A plurality of processes can be used to manufacture a link 20, enabling the layer of elastomeric material 20 to be placed on the one-piece metal part 11. Possible processes include vulcanization of a vulcanizable elastomeric material. In this case, the vulcanization is carried out using heat and pressure. A variation of vulcanization is cold bonding. Note that the layer of elastomeric material 20 may be reinforced. Such a reinforcement could, for example, be a fabric. This fabric can advantageously be colored, for example red, to serve as an easily visible and detectable wear indicator for the layers of elastomeric material 20 on each of the links 10.

To ensure continuity of support of the support carriage 1 on a layer of elastomeric material 20, the layers of elastomeric material 20 of the links 10 partially overlap pairwise in a direction perpendicular to the transverse direction of the frame 210, i.e. in a longitudinal direction here. In particular, this feature is achieved by the fact that the opposing surface 19 of each link 10 is covered by the layer of elastomeric material 20 covering the central portion 12 and at least part of each of the fingers 15 of the two end portions 13, 14, for each of the links 10 of the crawler track 100.

In particular, in this embodiment, the layer of elastomeric material 20 of each of the links 10 completely covers a main portion 21 of the opposing surface 19 delimited by the two axes of articulation A1, A2, and covers at least part of the fingers 15 of the two end portions 13, 14 beyond the main portion 21.

As can be seen in particular in FIG. 7, in an assembled position of the links 10, the fingers 15 of one end portion of each link 10 of the crawler track 100 inserted into the finger-free spaces 16 of one of the end portions of the adjacent link 10, the layer of elastomeric material 20 extending beyond the main portion 21, a criss-crossing of the adjacent layers of elastomeric material 20 pairwise is obtained at one end portion 13, 14 of each link 10.

To guarantee the necessary and sufficient strength of the layer of elastomeric materials 20, this is configured so that the layer of elastomeric material 20 has a thickness e greater than or equal to 6 mm, preferably greater than or equal to 10 mm, and/or less than or equal to 15 mm, preferably less than or equal to 12 mm. For the same reasons of strength, the elastomeric material constituting the layer 20 is chosen to have a hardness greater than or equal to 92 Shore A, and/or less than or equal to 97 Shore A.

The elastomeric material used can be natural or synthetic. Rubber is an example of an elastomeric material that can be used in this application.

The fingers 15 of the links 10 have rounded ends, the rounding of each of said fingers 15 being delimited by a rounded connecting face 150 forming the junction between a face of the rolling surface 18 and a face of the opposing surface 19. A center of curvature of the rounded connecting face 150 is preferably contained in the geometric reference plane P containing the two axes of articulation A1, A2. The connecting face 150 is rounded so as to be convex. In the area of the fingers 15, the rounded connecting faces 150 delimit the associated link 10 longitudinally.

The layer of elastomeric material 20 has inclined portions, for example curved or chamfered 22, each covering a rounded portion of the rounded end of each of the fingers 15 on the side of the surface 19 opposite the running surface 18.

The fingers 15 of each of the two end portions 13, 14 have flat transverse guide side faces 151 perpendicular to the axes of articulation A1, A2 and delimiting the finger-free spaces 16 in pairs transversely.

Longitudinally, the finger-free spaces 16 of each of the two end portions 13, 14 have a face 160 forming a space bottom with a shape complementary to that of the finger 15 it accommodates. In particular, the bottoms of the spaces 16 locally delimit the associated link 10 longitudinally and have a concave rounded face whose curvature is equal to that of the rounded connecting faces 150 of the associated fingers. In this way, the links 10 articulated in pairs are rotationally guided while protecting the connection from the external environment, such as dust or rubble.

The main portion 21 of the opposing surface 19 of each of the links 10 is flat so as to maximize the contact surface and the distribution of forces when the links are resting on the rail-free section of the railway line.

The layer of elastomeric material 20 is formed in one piece and is continuous, i.e. without discontinuities such as holes, so as to improve its grip on the one-piece metal part 11. The layer of elastomeric material 20 also has a constant thickness e, even when it covers at least part of the fingers 15 of both end portions 13, 14 beyond the main portion 21. This ensures uniform protection of the rail-free section of the railway line. with the associated crawler track 100, even in articulated areas, at the articulations between links 10.

As shown in detail in FIG. 8, each link is configured so that a center-to-center distance d measured between the axes of articulation A1, A2 of the end portions 13, 14 is greater than or equal to 45 mm and/or, preferably, less than or equal to 55 mm. In this way, the contact surface is maximized and a sufficient distribution of forces across different links 10 is guaranteed.

A center-to-center distance D between two adjacent rollers 220 is greater than or equal to 45 mm and/or less than or equal to 55 mm to maximize the number of load transfer points on each sleeper 2.

In addition, the rollers 220 are rotatably mounted about axes B parallel to the axes of articulation A1, A2 of the links 10. A center-to-center distance D of the rollers is configured so as to be strictly greater than the value of the center-to-center distance d between the axes of articulation A1, A2 of the links 10 and strictly less than the value of twice the center-to-center distance d between the axes of articulation A1, A2 of the links 10. It is understood that all the rollers have the same center-to-center distance D. Likewise, all the links 10 are identical and have the same center-to-center distance d.

To further maximize this number of transfer points, each running gear 200 is configured so that the axes of rotation B of at least twenty coplanar rollers 220 among the rollers 220 lie in the same plane. In the embodiment shown here, the center-to-center distance D of the rollers 220 is configured so that always at least three rollers rest on a sleeper 2 and/or, preferably, and the length of the support carriage 1 is configured so that it always rests on at least three sleepers 2, preferably four sleepers 2. For this purpose, a length of a subset of the coplanar rollers 220 is preferably greater than or equal to 1800 mm, and even more preferably greater than or equal to 1950 mm.

To avoid premature wear of the chamfers on the sleepers 2, the frame 210 of each running gear 200 has at least one end portion, carrying end rollers 221 so that, along this end portion, the links 10 run along an oblique plane, i.e. their geometric reference plane P is inclined with respect to the running plane P0.

For ease of manufacture and to reduce unit costs, all links 10 on the track 100 and on the support carriage 1 are identical. To allow successive criss-crossing of the end portions 13, 14 of the links 10 pairwise, even though they are identical, the fingers 15 of one of the two end portions 13, 14 are each positioned between two planes P1, P2 perpendicular to the axes of articulation A1, A2 and delimiting spaces 16 free of fingers of the other of the two end portions 13, 14.

Of course, the invention is described in the foregoing by way of example. It is understood that a person skilled in the art is able to produce different variant embodiments of the invention without departing from the scope of the invention.

It is emphasized that all of the features, as they are taught to a person skilled in the art from the present disclosure, drawings and attached claims, even though specifically they have been described in relation to other determined features, both individually and in any combinations, may be combined with other features or feature groups disclosed herein, provided that this has not been expressly excluded and that no technical circumstances make such combinations impossible or nonsensical.

1. A crawler track link for a support carriage of a machine for laying or renovating a railway line, comprising a one-piece metal part defining two axes of articulation that are parallel to and spaced apart from one another, the one-piece metal part having a central portion located between the two axes of articulation and two opposing end portions on either side of the central portion, each of the end portions being associated with one of the two axes of articulation and comprising a plurality of parallel fingers which are separated in pairs by finger-free spaces and through which holes pass, which holes are aligned along an associated axis of articulation, the one-piece metal part comprising a rolling surface situated on one side of a geometric reference plane that contains the two axes of articulation and a surface opposite to the rolling surface, located on another side of the geometric reference plane, the opposing surface being covered with a layer of elastomeric material that covers the central portion and at least part of each of the fingers of the two end portions.

2. The link for a crawler track according to claim 1, wherein the layer of elastomeric material completely covers a main portion of the opposing surface delimited by the two axes of articulation, and covers at least part of the fingers of the two end portions beyond the main portion.

3. The link for a crawler track according to claim 2, wherein the main portion of the opposing surface is flat.

4. The link for a crawler track according to claim 1, wherein the layer of elastomeric material has a thickness greater than or equal to 6 μm.

5. The link for a crawler track according to claim 1, wherein the end of each of the fingers is rounded, the rounding of each of said fingers being delimited by a rounded connecting face configured to form a junction between a face of the rolling surface and a face of the opposing surface.

6. The link for a crawler track according to claim 5, wherein the layer of elastomeric material has inclined, for example curved or chamfered portions, each covering a rounded portion of the end of each of the fingers on the side of the surface opposite the rolling surface.

7. The link for a crawler track according to claim 1, wherein the layer of elastomeric material is continuous.

8. The link for a crawler track according to claim 1, wherein the layer of elastomeric material has a hardness greater than or equal to 92 Shore A, and/or less than or equal to 97 Shore A.

9. The link for a crawler track according to claim 1, wherein a center-to-center distance taken between the axes of articulation of the end portions is greater than or equal to 45 mm and/or less than or equal to 55 mm.

10. The link for a crawler track according to claim 1, wherein at least some of the fingers on each of the two end portions have flat transverse guide side faces perpendicular to the axes of articulation, delimiting the finger-free spaces pairwise.

11. The link for a crawler track according to claim 1, wherein the fingers of one of the two end portions are each positioned between two planes perpendicular to the axes of articulation and delimiting spaces without fingers of the other of the two end portions.

12. The link for a crawler track according to claim 1, wherein the rolling surface comprises two rolling tracks separated by a guide rib.

13. An articulated assembly (100′) of at least two links of claim 1, wherein the fingers of an end portion of a first of the two links are inserted into finger-free spaces of an end portion of a second of the two links so as to be criss-crossed, the articulated assembly (100′) further comprising a hinge pin inserted into holes of each of the criss-crossed fingers of the first of the two links and the second of the two links.

14. The articulated assembly (100′) according to claim 13, wherein the links are identical.

15. A crawler-track running gear for a support carriage of a machine for laying or renovating a railway line, comprising a crawler consisting of an articulated assembly (100′) of a plurality of links according to claim 13 assembled successively in pairs and comprising a frame carrying rollers for guiding the crawler track for rolling on the rolling surfaces of the links of the crawler track.

16. The crawler-track running gear according to claim 15, wherein a center-to-center distance between two adjacent rollers is greater than or equal to 45 mm and/or less than or equal to 55 mm.

17. The crawler-track running gear according to claim 15, wherein the rollers have axes parallel to the axes of articulation of the links, a center-to-center distance of the rollers being strictly greater than a value of a center-to-center distance between the axes of articulation of a link and strictly less than the value of twice the center-to-center distance between the axes of articulation of a link.

18. A support carriage of a machine for laying or renovating a railway line, wherein the support carriage comprises at least two crawler-track running gears of claim 15.

19. The link for a crawler track according to claim 1, wherein the layer of elastomeric material has a constant thickness.
